(19) United States
(12) Patent Application Publication
(10) Pub. No.: US 2013/0195248 A1
(43) Pub. Date: Aug. 1, 2013

(54) Hand-Held X-Ray Backscatter Imaging Device

(71) Applicant: American Science and Engineering, Inc., Billerica, MA (US)

(72) Inventors: Peter Rothschild, Newton, MA (US); Lee Grodzins, Lexington, MA (US); Paul Bradshaw, Newton, MA (US); Louis Wainwright, Andover, MA (US)

(73) Assignee: AMERICAN SCIENCE AND ENGINEERING, INC., Billerica, MA (US)

(21) Appl. No.: 13/750,134

(22) Filed: Jan. 25, 2013

Related U.S. Application Data
(60) Provisional application No. 61/591,360, filed on Jan. 27, 2012.
(60) Provisional application No. 61/598,521, filed on Feb. 14, 2012.
(60) Provisional application No. 61/598,576, filed on Feb. 14, 2012.
(60) Provisional application No. 61/607,066, filed on Mar. 6, 2012.

(51) Int. Cl. G01N 23/203

(52) U.S. Cl. CPC G01N 23/203
USPC 378/86

(57) ABSTRACT

Apparatus for imaging items behind a concealing barrier. A source of penetrating radiation is contained entirely within a housing. A spatial modulator forms the penetrating radiation into a beam and sweeps the beam to irradiate an inspected object. A detector generates a scatter signal based on penetrating radiation scattered by contents of the inspected object, and a sensor senses motion relative to a previous position of the apparatus with respect to the inspected object. A processor receives the scatter signal and generates an image of the contents of the inspected object based at least on the scatter signal. The housing may be adapted for singled-handed retention by an operator

The present application claims the priority of U.S. Provisional Patent Application Ser. No. 61/591,360, filed Jan. 27, 2012, and of U.S. Provisional Patent Application Ser. Nos. 61/598,521, and 61/598,576, both filed Feb. 14, 2012, and U.S. Provisional Patent Applications Ser. No. 61/607,066, filed Mar. 6, 2012, all of which applications are incorporated herein by reference.

### TECHNICAL FIELD

The present invention relates to systems and methods for x-ray imaging, and, more particularly, to systems and methods for x-ray imaging employing detection, at least, of scattered x-rays.

### BACKGROUND ART

X-ray backscatter techniques have been used over the last 25 years in order to detect items located behind a concealing barrier, without requiring the need to place an x-ray detector distal to the object being imaged (relative to the x-ray source). This has proven to be very beneficial for certain imaging applications, such as the one-sided inspection (i.e., with detector and source on the same side of the object) of vehicles, cargo containers, suitcases, and even people.

To date, however, these devices have tended to be fairly large and heavy due to the size and weight of the x-rays sources, the beam-forming mechanism that is needed to create the scanning pencil beam, and the detectors that detect the backscattered x-rays.

A backscatter device for detection of structure hidden by a wall has been suggested by Japanese Laid-Open Publication No. 10-185842 (hereinafter, “Toshiba '842”), filed Dec. 12, 1996, and incorporated herein by reference. The apparatus described in Toshiba '842 can provide no more than an instantaneous image of a region within the scan range, at any moment, of a source held by an operator.

Recently, the development of compact, light x-ray sources that operate at moderate power (in the range, typically, between 1-20 Watts) at relatively high x-ray energies (50-120 keV), along with small and very efficient electric motors to drive a rotating beam-forming chopper wheel, have allowed for the design and development of light and compact hand-held backscatter imaging systems.

In addition, prior-art backscatter x-ray systems using x-ray tubes, such as described, for example, in U.S. Pat. No. 5,763,886 (to Schulte) have always provided a means to move either the object or the imaging system in relative motion with respect to each other along the ‘scan” direction, which is typically in a direction perpendicular to the plane containing a raster-scanning x-ray beam created by a chopper wheel. For example, to inspect an object having a vertical surface (such as a wall, for example, or a piece of baggage), the x-ray beam is typically scanned in a vertical plane, with the object being inspected moved in a horizontal direction. This is typical of systems that scan baggage, where the bag is moved in a horizontal direction on a conveyor belt, or for systems that scan vehicles, in which the vehicle drives past (or through) the system or alternatively, the system is moved in a horizontal direction past a stationary vehicle. For personnel scanners using x-ray backscatter, the beam is typically scanned in the horizontal plane, with the source assembly moved past a stationary person in the vertical direction. In either case, to create a 2-dimensional backscatter image, there must be relative motion of the system and the object being scanned, and this requirement usually adds significant additional weight, size, and complexity to the imaging system.

### SUMMARY OF EMBODIMENTS OF THE INVENTION

In accordance with various embodiments of the present invention, an imaging apparatus is provided. The apparatus has a housing and a source of penetrating radiation contained entirely within the housing for generating penetrating radiation. Additionally, the apparatus has a spatial modulator for forming the penetrating radiation into a beam for irradiating the object and for sweeping the beam, a detector for generating a scatter signal based on penetrating radiation scattered by contents of the inspected object, a sensor for sensing motion of the apparatus relative to a previous position of the apparatus with respect to the inspected object and a processor for receiving the scatter signal and for generating an image of the contents of the inspected object based at least on the scatter signal.

The housing may be adapted for single-handed retention by an operator, and, in certain embodiments, the sensor may be a mechanical encoder, or an accelerometer, or an optical sensor, to cite three examples. The processor may be adapted to modulate an intensity of the penetrating radiation based on sensed motion of the apparatus.

In other embodiments of the present invention, the backscatter imaging apparatus also has a friction mitigator adapted to provide contact between the apparatus and the inspected object. The friction mitigator may include wheels, roller castors and low-friction pads.

In yet further embodiments, there may be one, two, or more handles coupled to the housing. There may be an interlock for deactivating the source of penetrating radiation if no object is detected within a specified proximity of the apparatus.

In alternate embodiments of the invention, a transmission detector is coupled to the apparatus as well. A backscatter shield may be provided that is adapted to deploy outward from the housing, where the backscatter shield may also be flexibly adapted to conform to a surface of an inspected object.

### BRIEF DESCRIPTION OF THE FIGURES

The foregoing features of the invention will be more readily understood by reference to the following detailed description, taken with reference to the accompanying figures, in which:

FIG. 1 depicts an exploded view of a hand-held x-ray backscatter device in accordance with an embodiment of the present invention.

FIG. 2 schematically depicts use of collimated detectors to reduce detection of near-field scatter, in accordance with embodiments of the present invention.

FIG. 3 shows a hand-held imaging device with a detachable single-channel transmission detector, in accordance with an embodiment of the present invention.

FIG. 4 shows a hand-held imaging device with a detachable multiple-channel transmission detector, in accordance with another embodiment of the present invention.

FIGS. 5A-5C show two-handed operation of a hand-hand backscatter device in accordance with an embodiment of the present invention.

### DETAILED DESCRIPTION OF EMBODIMENTS OF THE INVENTION

### Definitions

As used in this description and in the appended claims, the term “image” refers to any multidimensional representation, whether in tangible or otherwise perceptible form or otherwise, whereby a value of some characteristic is associated with each of a plurality of locations corresponding to dimensional coordinates of an object in physical space, though not necessarily mapped one-to-one thereonto. Thus, for example, the graphic display of the spatial distribution of some feature, such as atomic number, in one or more colors constitutes an image. So, also, does an array of numbers in a computer memory or holographic medium. Similarly, “imaging” refers to the rendering of a stated physical characteristic in terms of one or more images.

Energy distributions of penetrating radiation may be denoted herein, as a matter of notational convenience, by reciting their terminal emitted energy (often called the “end-point” energy). Thus, for example, an x-ray tube emitting bremsstrahlung radiation due to electrons accelerated through a potential of 100 kV, will emit x-rays of energy less than 100 keV, and the spectrum of emitted radiation may be characterized, herein, as a “100 keV beam,” and an image of detected radiation scattered from that beam may be referred to herein as a “100 keV scatter image.”

As used in this description, and in any appended claims, the terms “high-Z” and “low-Z” shall have connotations relative to each other, which is to say that “high-Z” refers to a material, or to a line of sight, characterized by an effective atomic number Z that is higher than a material or line of sight referred to, in the same context, as “low-Z”.

### Description of Embodiments

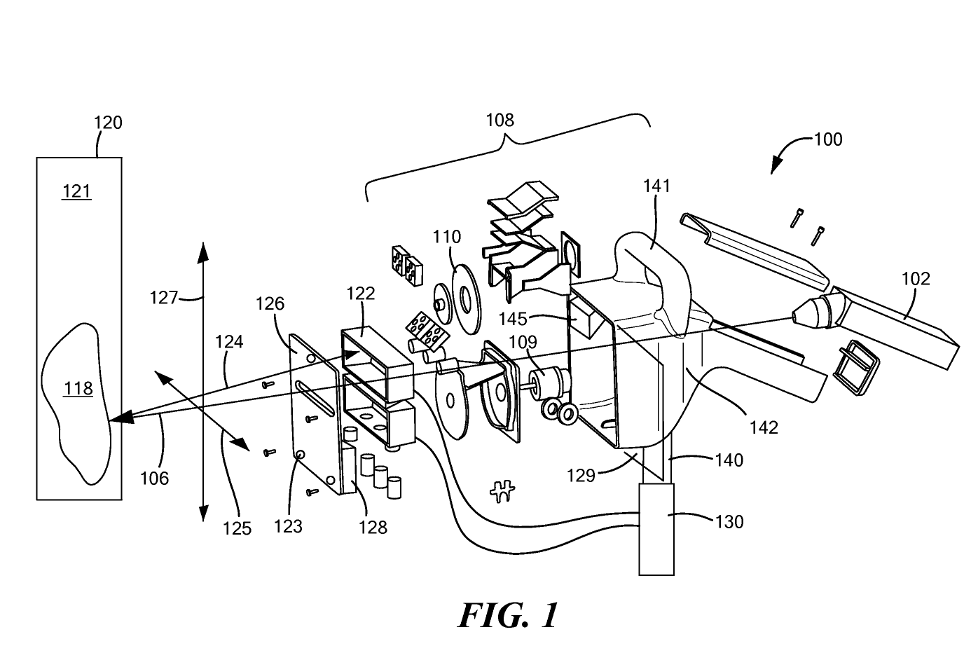

A backscatter imaging apparatus 100 in accordance with embodiments of the present invention is now described generally with reference to FIG. 1. A source 102 of penetrating radiation, which may be an x-ray tube, for example, as shown, or may also be any other source of particles (such as gamma rays) of penetrating radiation, emits penetrating radiation that is formed into a beam 106 by means of a beam-forming (or collimating) structure designated generally by numeral 108. Such beam-forming structures are well-known In the art, and all such structures are encompassed within the scope of the present invention.

Beam 106 is temporally chopped, as by chopper wheel 110, driven by motor 109, though any other means of chopping beam 106 may be practiced within the scope of the present invention. The mechanism employed for shaping beam 106 and for temporally interrupting, and spatially scanning, beam 106 may be referred to, herein, as a spatial modulator. Beam 106 impinges upon a surface 120 of an inspected object 121 external to apparatus 100. Penetrating radiation 124 scattered by contents 118 within, or posterior to, surface 120, is detected by one or more backscatter detectors 122, each coupled to a processor 130 for forming a backscatter image of object 121. Detectors 122 may employ wavelength-shifting fiber coupling of scintillation, thereby allowing thin-profile detectors to be deployed outward from a folded configuration with respect to a housing 142. Imaged object 121 may be the internal sheet-rock wall of a building, or a crate or box, while numeral 120 designates the surface of that wall, crate or box.

In accordance with preferred embodiments of the present invention, the imaging apparatus 100 scans the x-ray beam 106 in a single linear path 125 (for example, along a line in the horizontal plane), using well-known scanning techniques, based on rotating slots relative to a fixed slit, etc. It is to be understood that the linear path of scanning may be arcuate, or otherwise curvilinear, within the scope of the present invention. Meanwhile, the operator moves the system in a “scan” direction 127 substantially perpendicular to this plane. (In the example depicted in FIG. 1, the scan direction is the vertical direction). This means that the system need not include mechanisms to provide this relative motion, allowing the system to be much simpler, lighter, and much more compact.

In order to provide stability while the system is in use, one or more friction mitigators 123 may be incorporated onto the front of the device, allowing the system to be pushed against the surface 120 of the object 121 being imaged. Friction mitigator 123 may include a set of wheels, roller castors, or low-friction pads, for example.

Referring, further, to FIG. 1, a miniature x-ray tube (emitting approximately 10 W, with an applied anode potential of approximately 70 kV) may serve as source 102 of penetrating radiation. Chopper wheel 110 driven by motor 109 creates the scanning pencil beam 106 of x-rays, as shown. Housing 142 is provided, in the embodiment shown, with two handles 140 and 141 so that single-handed or two-handed operation of the device 100 is facilitated, depending on what is easiest for the operator.

In accordance with preferred embodiments of the invention, the center of mass of imaging device 100 is configured so that the front face 126 of the device remains in full contact with the face 120 of the object being scanned, even when the device is only held by the upper handle. This reduces any torsion forces on the operators arm and wrist, reducing fatigue and making the device easier to use.

### Correcting for Variable Scan Speed and Scan Direction

One of the limitations of relying on the operator to provide the relative motion in the “scan” direction is the variability of the scan speed and direction which will occur, due to operator inexperience or fatigue, or due to uneven surfaces. In accordance with embodiments of the current invention, variability in scan speed may be accommodated by incorporating one or more sensors 145 or position encoders that allow the current position to be inferred relative to a previous position so that the aspect ratio of the image may be dynamically corrected, scan line by scan line. For example, if the operator slows down the relative motion during part of the scan, the encoder or sensor informs the software executed by processor 130 that this is occurring, and the imaging software may then average several lines together so that no distortion is apparent in the image displayed to the operator. Conversely, if the operator speeds up the motion during part of the scan, the software can interpolate additional lines into the image so that, again, no distortion in the image is apparent. In addition, the encoders can be used to correct for variability in the scan direction, correcting the image, for example, if adjacent swaths of image are not completely parallel to one another. The encoders or position sensors may include, but are not limited to, an optical or mechanical mouse, encoders coupled to wheels or roller balls, or accelerometers that monitor changes in the scan speed.

An additional embodiment of the invention allows for the anode current of x-ray tube 102 to be changed dynamically, depending on the instantaneous scan speed of the device. For example, if the scan speed is reduced by a factor of two, the anode current may be reduced by a factor of two. This means that even though the scan would take twice as long to complete, the total radiation dose per scan to the operator and the environment remains the same, increasing the safety of the device.

### Image “Stitching”

The use of position sensors or accelerometers 145 also allows the images from small area scans to be “stitched” together to create a larger image, with a substantially larger format. For example, the operator may first scan a 12-inch wide vertical swath of a wall, and then move on to an adjacent vertical swath. Since the system knows the location (at least, relative to an initial point, though not necessarily an absolute position) of the x-ray beam at any given time, the images corresponding to each swath can be joined together by a system computer or controller 130 to create one image containing multiple swaths. Algorithms for stitching disparate images are known in the art, as surveyed, for example, in Szelinski, “Image Alignment and Stitching: A Tutorial,” Technical Report MSR-TR-2004-92, Microsoft Corporation, in Paragios (ed.), Handbook of Mathematical Models in Computer Vision, pp. 273-92 (2005).

### Enhancement of Radiation Safety

Another important set of considerations with hand-held device 100 concerns radiation safety. In accordance with embodiments of the present invention, an operator and others in the immediate vicinity may be protected using one or more of the following interlocking features:
1. The detected backscatter signal is constantly monitored by processor 130, and if it falls below a pre-defined threshold, it means front face 126 of the device is not in close proximity to a wall, or other object 121, which is an undesirable circumstance;
2. A sensor (mechanical, capacitive, etc.) 128 may disable the x-rays if the front face of the device is not adjacent to a solid surface;
3. A sensor (optical, acoustic, etc.) may measure the distance of the device from the nearest object, and deactivate the x-rays if no object is detected within a certain distance; and
4. A motion sensor, such as accelerometer 145, may deactivate the x-rays if the device is stationary and not in motion.

In addition to interlocks, another embodiment of the invention employs fold-out scatter shields 129 which reduce the radiation dose to the operator. Shield 129 may be rigid or flexible to allow for use of the system in tight corners. Rigid shields may be made of thin lead, tungsten, or steel (for example). Flexible shielding materials include the use of flexible plastic impregnated with lead or tungsten powder.

### Detector Collimation

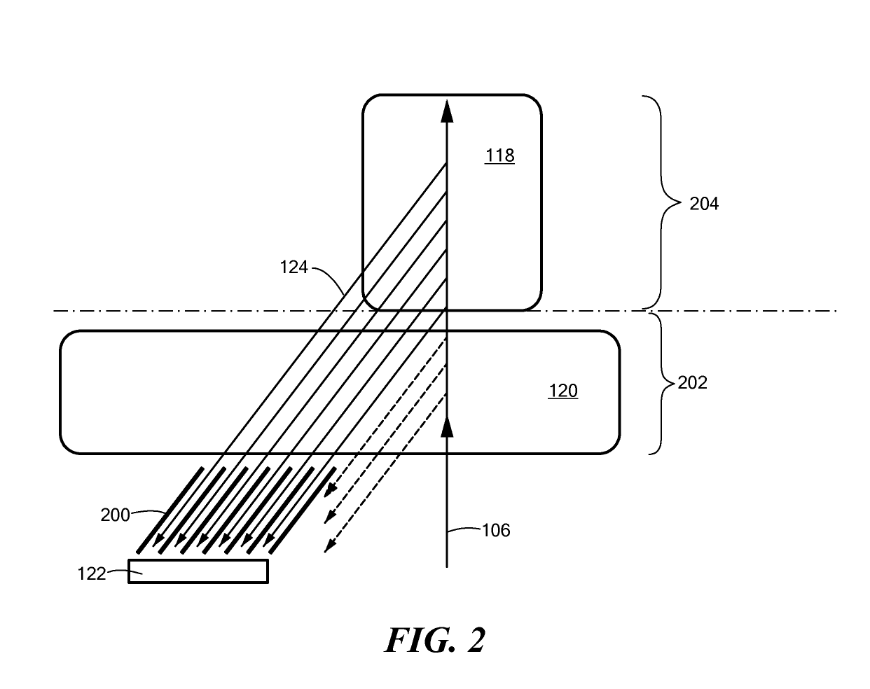

Referring now to FIG. 2, many of the backscattered x-rays 124 that are detected in the backscatter detectors 122 of the device are scattered from the first object 120 illuminated by the beam, which in many cases will be the obscuring barrier, such as a wall or the door of a locker. This has the effect of reducing the ability to see objects 118 behind the barrier, as these “near field” x-rays tend to fog the image, and reduce the contrast of the deeper objects. Since the near-field scatter originates from a point close to the device, it is advantageous that the backscatter detectors be physically collimated in such a way that radiation from the near-field 202 is blocked from entering the detectors, with only scatter from the far-field 204 being detected, as shown in FIG. 2. This results in an improved Signal-to-Noise Ratio (SNR) for imaging the deeper objects. The collimation can be performed using one or more thin vanes 200 of x-ray absorbing material placed in front of the backscatter detectors (for example, lead, tungsten, brass, or steel) positioned and angled such that the near-field radiation is not able to pass between the vanes and into the detector.

In addition to using standard collimation techniques, a technique called “Active Collimation” can be used on the hand-held device to simultaneously detect scattered x-rays from both the near field and the far field. This technique is described in U.S. patent application Ser. No. 13/163,854, filed Jun. 20, 2011, which is incorporated herein by reference.

### Transmission Imaging

In addition to performing x-ray backscatter imaging, hand-held backscatter imaging device 100 may also be used to create transmission images. This requires that a transmission detector be placed behind the object being imaged. Since the device uses a scanning pencil beam 106 of x-rays (shown in FIG. 1) instead of a cone or fan beam, the detector does not have to be an expensive pixilated detector, but can be a single channel detector that covers enough area to intercept all the x-rays transmitted through the object. This detector can be similar to a backscatter detector, but includes a scintillator that is optimized for detecting x-rays in the primary beam instead of scattered x-rays. This configuration allows for a very compact and lightweight detector design, enhancing the portability of the device. For example, the device may then be used by a bomb squad to scan suspicious objects (such as an abandoned package) in both backscatter and transmission modalities, greatly enhancing the ability to detect explosive devices.

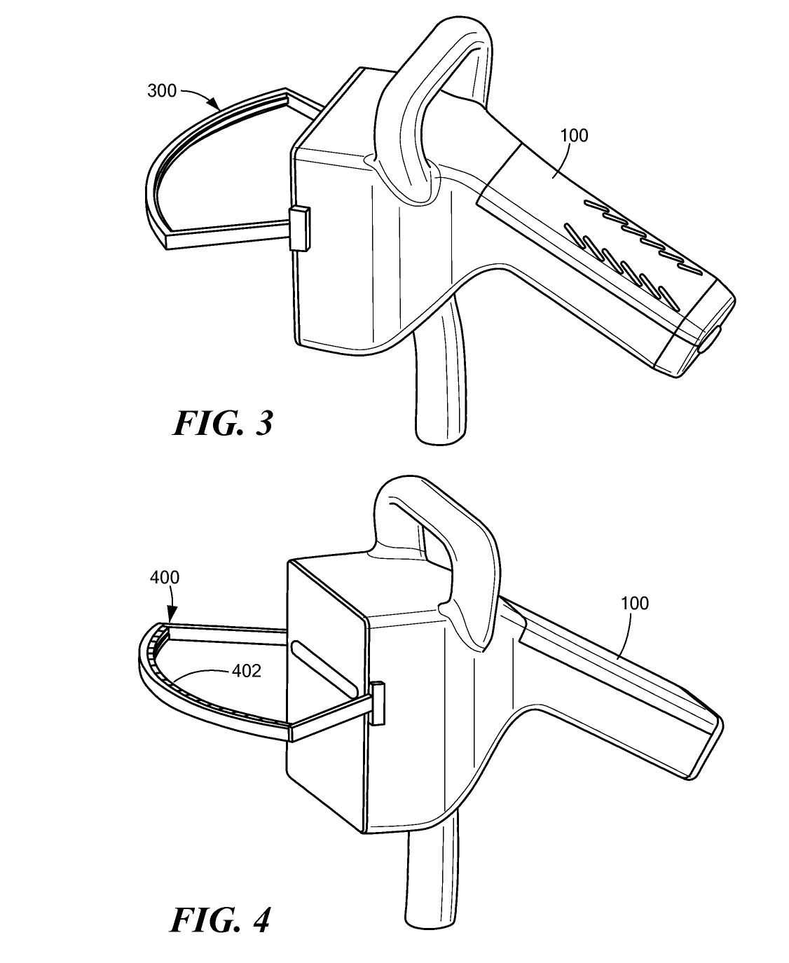

An embodiment for using the device in transmission mode with a single-channel one-dimensional transmission detector 300 attached to the device is shown in FIG. 3. In this case, the transmission detector 300 is attached to the handheld device 100 and intercepts the transmitted beam as it sweeps in the horizontal plane on the far side of the object being inspected. Transmission detector 300 may be detachable, so that the device may be used with or without transmission imaging. This embodiment of the invention may advantageously be used, for example, to image a continuous length of pipe. With the transmission detector attached, the device is suitable for inspecting items such as pipes or wooden beams for flaws or defects due to fatigue, with both backscatter and transmission images being created simultaneously.

A final embodiment for enabling the device to perform transmission imaging is to have a removable or switchable beam-forming mechanism 108 (shown in FIG. 1) that allows the device to switch from producing a sweeping pencil beam to producing a fan beam. In its fan-beam mode, imaging device 100 may be combined with a detachable high-resolution segmented array transmission detector 400 which contains many small detector elements 402 as shown in FIG. 4. The embodiment of the invention depicted in FIG. 4 is of particular advantage in high-resolution imaging of long structures such as pipes or wooden beams.

### Backscatter Detector Configurations

Numerous embodiments of the invention utilize different configurations for the backscatter detectors to enhance performance or to provide additional information. Some are listed, below, by way of example:
1) Fold-out detectors to provide greater detector area. This allows for a very compact device in terms of stowage and mobility, but allows for higher imaging performance to be achieved. This is particularly useful when the stand-off distance must be larger due to space constraints or because a large area must be scanned, and it is faster to scan from a larger distance. These fold-out detectors advantageously provide additional scatter shielding to the operator, and optionally also contain additional material to enhance their shielding capability, such as lead or tungsten impregnated plastic.
2) Asymmetric detector size or placement to provide information on the depth of the object being imaged, and therefore providing some 3D information, as described in U.S. Pat. No. 6,282,260, which is incorporated herein by reference.
3) Additional portable detector modules may be positioned close to the object 121 being scanned. These modules can be self-contained in terms of power and send their output signals to the data acquisition system wirelessly (including optically), or they can have cables which can be plugged into the hand-held device or the docking station.

### Variable Imaging Resolution

Depending on the objects being scanned, the required scan times, or the stand-off distance of the device from the object being imaged, it may be advantageous to be able to dynamically change the imaging resolution of the system. This is most easily achieved by varying the width of the collimator that defines the dimension of the beam along the scan direction (this is the beam dimension perpendicular to the sweep direction and parallel to the scan direction of the device over the object). If the device is very close to the object being scanned, a reduction of two in the collimator width will increase resolution almost by a factor of two in the scan direction. This will also have the added benefit of reducing dose per unit time to the environment.

For example, for an initial high-speed scan of an object, the width of the collimator may be increased, resulting in higher beam flux (i.e. faster scanning) but lower resolution. If something suspicious is detected in the first low-resolution image, a secondary, higher-resolution scan may be performed with a reduced collimator width. The width of the collimator may be adjusted manually with a mechanical lever, or, alternatively, the collimator width may be adjusted electrically using electro-mechanical actuators or stepper motors.

### Remote Power Supply or Docking Station

One of the limitations of a hand-held device operated off a battery is often the length of time that the device can be used before requiring that the battery be recharged. Because the x-ray tube described in the invention only uses about 10 Watts of electron current on the anode, the total power consumption of the device can be quite low, and operating times using a lithium ion battery can be quite substantial.

For applications requiring many scans or scans over large areas, however, it may be advantageous to use a larger power supply that is not mounted in the hand-held device. The battery or other type of supply (e.g. a fuel cell) may be mounted on the operator's belt, in a backpack worn by the operator, or in a separate module placed on the floor, for example, or on a wheeled cart.

In accordance with another embodiment of the invention, a portable or non-portable docking station is provided in which the hand-held device is placed. The docking station can provide one or more of four major functions:
1) Supports the device and moves it at a controlled speed for performing high-resolution backscatter and/or transmission imaging;
2) Provides additional power to lengthen operating times;
3) Recharges the battery of the device; or
4) Provides electrical connections for downloading images and/or diagnostic information.

### Further Alternate Embodiments

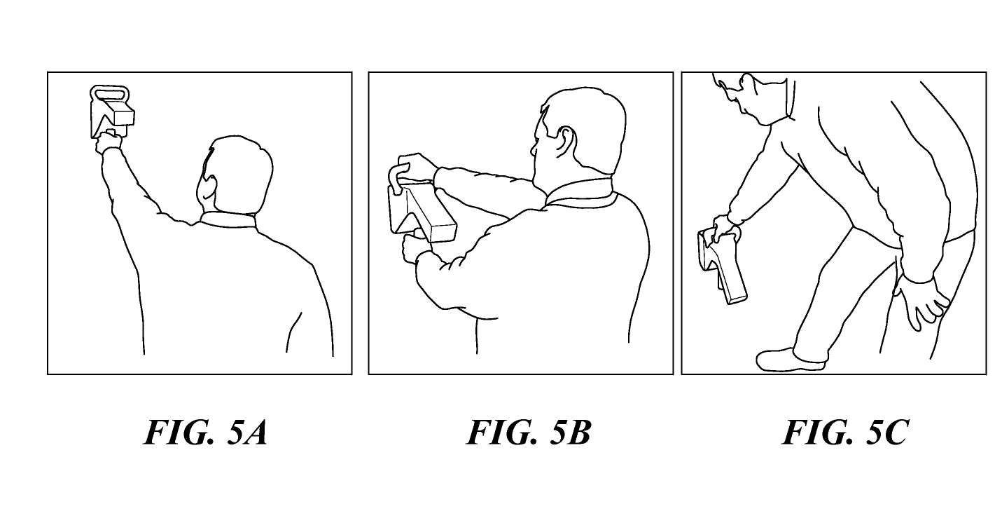

In certain embodiments of the invention, depicted in FIGS. 5A-5C, device housing 142 includes an embodiment whereby the device housing has both an upper handle 141 and a lower handle 140, where housing and handles are designated in FIG. 1. This allows the device to be held with the lower handle for regions of the scan that are high off the ground, and by the upper handle for scanning regions close to the floor. It is also designed so that the system can be swept in a single continuous motion from as high as the operator can comfortably reach (as shown in FIG. 5A) all the way to the ground (as shown in FIG. 5C), using the following sequence:
1) One hand only on the lower handle (top of the scan), as in FIG. 5A;
2) Both hands on both handles simultaneously (middle of the scan), as in FIG. 5B;
3) One hand only on the upper handle (bottom of the scan), as in FIG. 5C.

The foregoing mode of operation may advantageously minimize fatigue to the operator by splitting the load between both arms, as well as maximizing the scan area per vertical sweep of the device.

Where examples presented herein involve specific combinations of method acts or system elements, it should be understood that those acts and those elements may be combined in other ways to accomplish the same objective of x-ray imaging. Additionally, single device features may fulfill the requirements of separately recited elements of a claim. The embodiments of the invention described herein are intended to be merely exemplary; variations and modifications will be apparent to those skilled in the art. All such variations and modifications are intended to be within the scope of the present invention as defined in any appended claims.

What is claimed is:

1. An imaging apparatus comprising:
a. a housing;
b. a source of penetrating radiation contained entirely within the housing for generating penetrating radiation;
c. a spatial modulator for forming the penetrating radiation into a beam for irradiating the object and for sweeping the beam;
d. a detector for generating a scatter signal based on penetrating radiation scattered by contents of the inspected object;
e. a sensor to sense motion relative to a previous position of the apparatus with respect to the inspected object; and
f. a processor for receiving the scatter signal and for generating an image of the contents of the inspected object based at least on the scatter signal.

2. An imaging apparatus in accordance with claim 1, wherein the housing is adapted for single-handed retention by an operator.

3. An imaging apparatus in accordance with claim 1, wherein the sensor is a mechanical encoder.

4. An imaging apparatus in accordance with claim 1, wherein the sensor is an accelerometer.

5. An imaging apparatus in accordance with claim 1, wherein the sensor is an optical sensor.

6. An imaging apparatus in accordance with claim 1, wherein the processor is adapted to modulate an intensity of the penetrating radiation based on sensed motion of the apparatus.

7. An imaging apparatus in accordance with claim 1, further comprising a friction mitigator adapted to provide contact between the apparatus and the inspected object.

8. An imaging apparatus in accordance with claim 7, wherein the friction mitigator is selected from a group including wheels, roller castors and low-friction pads.

9. An imaging apparatus in accordance with claim 1, further comprising at least one handle coupled to the housing.

10. An imaging apparatus in accordance with claim 1, further comprising two handles coupled to the housing.

11. An imaging apparatus in accordance with claim 1, further comprising an interlock for deactivating the source of penetrating radiation if no object is detected within a specified proximity of the apparatus.

12. An imaging apparatus in accordance with claim 1, further comprising at least one collimator for attenuating detected radiation from material within a specified proximity of the apparatus.

13. An imaging apparatus in accordance with claim 1, further comprising a transmission detector coupled to the apparatus.

14. An imaging apparatus in accordance with claim 1, further comprising a backscatter shield coupled to the apparatus.

15. An imaging apparatus in accordance with claim 14, wherein the backscatter shield is adapted to deploy outward from the housing.

16. An imaging apparatus in accordance with claim 13, wherein the backscatter shield is flexibly adapted to conform to a surface of an inspected object.
